(19) United States
(12) Patent Application Publication
(10) Pub. No.: US 2019/0275486 A1
(43) Pub. Date: Sep. 12, 2019

(54) PLANT AND PROCESS FOR PYROLYSIS OF MIXED PLASTIC WASTE

(71) Applicant: FUTURE ENERGY INVESTMENTS PTY LTD, Melbourne, Victoria (AU)

(72) Inventors: Kon Peltekis, Melbourne, Victoria (AU); Bala Kumble, Melbourne, Victoria (AU); Craig Astill, Melbourne, Victoria (AU)

(21) Appl. No.: 16/307,602

(22) PCT Filed: Jun. 30, 2017
(86) PCT No.: PCT/AU2017/050682

§ 371 Date: Dec. 6, 2018

(30) Foreign Application Priority Data
Jun. 30, 2016 (AU) 2016902564

(51) Int. Cl. B01J 6/00; C10G 1/10; C10G 1/00; C10L 1/08; C10B 53/07; C10B 57/00; C10B 45/00

(52) U.S. Cl. CPC B01J 6/008; C10L 2290/60; C10G 1/002; C10L 1/08; C10B 53/07; C10B 57/005; C10B 45/00; C10L 2290/06; C10L 2200/0469; C10L 2290/02; C10L 2290/08; C10L 2270/026; C10L 2290/543; C10L 2290/58; C10G 1/10

(57) ABSTRACT

A plant, comprising: a pyrolysis reactor configured to heat molten mixed plastic waste to produce: pyrolysis gases at a first temperature of around 350° C. to 425° C.; and pyrolysis slurry or pyrolysis char at a second temperature of 722° C. to 1400° C.

### FIELD

The present invention relates to a plant and related process for pyrolysis of mixed plastic waste.

### BACKGROUND

Pyrolysis plants and processes may be used to convert mixed plastic waste feedstock into pyrolysis products comprising pyrolysis gases, pyrolysis condensates, non-condensable pyrolysis gases, pyrolysis slurry, and pyrolysis char. The pyrolysis condensates may be fractionated into fuel products comprising syngas, crude oil and diesel.

Existing pyrolysis plants and processes suffer from various drawbacks. The production of uniform, high quality fuel products may be complicated by variation in the quality of the mixed plastic waste feedstock and the resulting variability in the composition of pyrolysis condensates, as well as disturbances in the process temperatures, volumes and flow rates of the gaseous and liquid pyrolysis products. The quality and yield of uniform, high quality fuel products may be further complicated by variations in the formation and composition of pyrolysis char that prevent full recovery of residual hydrocarbons to leave inert carbon char that may be recycled to the environment as landfill.

In this context, there is a need for improved pyrolysis plants and processes.

### SUMMARY

According to the present invention, there is provided a plant, comprising:

a pyrolysis reactor vessel configured to heat molten mixed plastic waste to produce:
pyrolysis gases at a first temperature of around 350° C. to around 425° C.; and
pyrolysis slurry or pyrolysis char at a second temperature of around 722° C. to around 1400° C.

The first temperature may be around 390° C. to around 410° C.

The second temperature may be around 1000° C. to around 1200° C.

The pyrolysis reactor vessel may be further configured to agitate the molten mixed plastic waste at the first temperature.

The pyrolysis reactor vessel may be provided on load cells configured to measure a percentage weight loss of the molten mixed plastic waste in the pyrolysis reactor vessel.

The pyrolysis reactor vessel may be made from a specialty alloy that is heat resistant up to the second temperature.

The pyrolysis reactor vessel may be heated by induction heating, gas burner heating, or a combination thereof.

The plant may further comprise a heated extruder configured to extrude and heat mixed plastic waste feedstock to an initial temperature of around 280° C. to around 320° C. to form the molten plastic waste that is fed into the pyrolysis reactor vessel.

The initial temperature of the molten plastic waste may be around 300° C.

The plant may further comprise a condenser configured to receive the pyrolysis gases from the pyrolysis reactor vessel, and to cool and condense the pyrolysis gases to a third temperature of around 150° C. to around 250° C. to produce pyrolysis condensates.

The third temperature may be around 180° C. to around 200° C.

The plant may further comprise a buffer tank configured to receive the pyrolysis condensates from the condenser, and to mix the pyrolysis condensates to produce a homogenous mixture thereof.

The buffer tank may be further configured to maintain the homogeneous mixture of the pyrolysis condensates at the third temperature.

The plant may further comprise a fluidised bed heater configured to receive the pyrolysis slurry or the pyrolysis char from the pyrolysis reactor vessel, and to heat and dry the pyrolysis slurry or the pyrolysis char at the second temperature.

The plant may further comprise a knock-out drum and a scrubber connected in series from an output of the buffer tank, and configured to separate non-condensable pyrolysis gases from the pyrolysis condensates.

The plant may further comprise a heater configured to receive the non-condensable pyrolysis gases from the scrubber, and to combust the non-condensable pyrolysis gases to heat one or both of the pyrolysis reactor vessel and the buffer tank.

The plant may further comprise a condensate analyser configured to analyse the homogenous mixture of the pyrolysis condensates in the buffer tank to selectively determine downstream processing of the homogenous mixture of the pyrolysis condensates to selectively produce fuel products.

The plant may further comprise downstream processing apparatus configured to selectively receive the homogenous mixture of the pyrolysis condensates from the buffer tank and, based on the analysing, to selectively process the homogenous mixture of the pyrolysis condensates to produce the fuel products.

The downstream processing apparatus may be selected from a condenser, a fractionator, a distillation column, and combinations thereof.

The fuel products may be selected from syngas, crude oil, diesel, bunker fuel, light fuel fractions, and combinations thereof.

The present invention also provides a process, comprising:
heating molten mixed plastic waste in a pyrolysis reactor vessel to produce:
pyrolysis gases at a first temperature of around 350° C. to around 425° C.; and
pyrolysis slurry or pyrolysis char at a second temperature of around 722° C. to around 1400° C.

The first temperature may be around 390° C. to around 410° C.

The second temperature may be around 1000° C. to around 1200° C.

The process may further comprise agitating the molten mixed plastic waste at the first temperature.

The process may further comprise weighing one or more of the molten mixed plastic waste, the pyrolysis slurry and the pyrolysis char in the pyrolysis reactor vessel.

The process may further comprise heating the pyrolysis reactor vessel by induction heating, gas burner heating, or a combination thereof.

The process may further comprise cooling and condensing the pyrolysis gases to a third temperature of around 150° C. to around 250° C. to produce pyrolysis condensates.

The third temperature may be around 180° C. to around 200° C.

The process may further comprise mixing the pyrolysis condensates in a buffer tank to form a homogenous mixture thereof.

The process may further comprise maintaining the homogeneous mixture of the pyrolysis condensates at the third temperature.

The process may further comprise extruding and heating mixed plastic waste feedstock to an initial temperature of around 280° C. to around 320° C. to form the molten plastic waste that is fed into the pyrolysis reactor vessel.

The initial temperature of the molten plastic waste may be around 300° C.

The process may further comprise heating and drying the pyrolysis slurry or the pyrolysis char at the second temperature in the pyrolysis reactor vessel or a fluidised bed heater.

The process may further comprise transferring the pyrolysis slurry or the pyrolysis char from the pyrolysis reactor vessel to the fluidised bed heater when a weight percentage of greater than around 70% of the molten mixed plastic waste has been pyrolysed.

The weight percentage may be around 80%.

The process may further comprise separating non-condensable pyrolysis gases from the pyrolysis condensates.

The process may further comprise combusting the non-condensable pyrolysis gases to heat one or both of the pyrolysis reactor vessel and the buffer tank.

The process may further comprise analysing the homogenous mixture of the pyrolysis condensates in the buffer tank to selectively determine fractionating of the homogenous mixture of the pyrolysis condensates to selectively produce fuel products.

The process may further comprise, based on the analysing, selectively downstream processing the homogenous mixture of the pyrolysis condensates to selectively produce the fuel products.

The downstream processing may be selected from condensing, fractionating, distilling, and combinations thereof.

The fuel products may be selected from syngas, crude oil, diesel, bunker fuel, light fuel fractions, and combinations thereof.

The present invention further provides the fuel products described above when made by the plant or the process described above.

The present invention further provides a method, comprising pyrolysing or disposing of mixed plastic waste at sea using the plant or the process described above on a sea vessel.

### BRIEF DESCRIPTION OF DRAWINGS

Embodiments of the invention will now be described by way of example only with reference to the accompanying drawings, in which:

FIG. 1 is a schematic diagram of a plant and process for pyrolysis of mixed plastic waste according to an embodiment of the present invention; and

FIG. 2 is a schematic diagram of optional downstream processing of pyrolysis products produced by the plant and process of FIG. 1.

### DESCRIPTION OF EMBODIMENTS

Referring to the drawings, a plant and process for pyrolysis of mixed plastic waste according to an embodiment of the present invention may comprise a hopper 1 suspended from a load cell (not shown) above a heated screw extruder 2 connected via a line 3 to a pyrolysis reactor vessel (or chamber) 4. An initial charge of raw mixed plastic waste feedstock may be weighed in the hopper 1 before being fed into the heated screw extruder 2. The raw mix plastic waste feedstock may comprise any and all mixtures of waste plastic materials of non-specific shape and non-specific composition. A metal detector (not shown), such as an induction metal detector, may be provided upstream of the heated screw extruder 2 to detect ferrous and non-ferrous metals that may be commingled in the raw mixed plastic waste. The heated screw extruder 2 may comprise a breaker plate (not shown). The mixed plastic waste may comprise a mixture of waste plastics, such as HDPE, PET, PP, PS, etc., commingled with metals, biomass or organic waste. The mixed plastic waste may be heated in the heated screw extruder 2 to form molten mixed plastic waste that flows via the line 3 into the top of the pyrolysis reactor vessel 4.

The heated screw extruder 2 may be configured to extrude and heat the mixed plastic waste feedstock to an initial temperature of around 280° C. to around 320° C. to form the molten plastic waste that may be subsequently fed into the pyrolysis reactor vessel 4. The initial temperature of the molten plastic waste may, for example, be around 300° C.

A vapour barrier 50 may be provided to isolate a safe area of the plant and process where the raw mixed plastic waste may be stored and prepared for processing from a hazardous area where the transformation of the raw mixed plastic waste to the molten plastic waste may involve fugitive emissions of pyrolysis gases or vapours. The safe zone may allow for positioning of operators and standard equipment without the need for hazardous ratings.

The pyrolysis reactor vessel 4 may be provided on load cells (not shown) to weigh the molten mixed plastic waste fed into the pyrolysis reactor vessel 4. This may enable the process and its efficiency to be monitored and controlled on a mass basis. Once the pyrolysis reactor vessel 4 load cells indicate the desired amount of molten mixed plastic waste has been added, the screw extruder 2 may be stopped. The molten mixed plastic waste in the line 3 may function as a process seal, preventing backflow of pyrolysis products as well as ingress of oxygen.

Prior to introduction of the molten mixed plastic waste into the pyrolysis reactor vessel 4 and commencement of process, an inert gas may be used to purge the reactor of any oxygen at ambient temperature. The temperature of the vapour space inside the pyrolysis reactor vessel 4 may then be raised to a temperature of around 350° C. The molten mixed plastic waste inside the pyrolysis reactor vessel 4 may be heated and agitated homogenously at a maintained temperature of around 390° C. to around 410° C. This may occur in the presence of an additive catalyst such as clay or bauxite.

The pyrolysis reactor vessel 4 may be configured to heat the molten mixed plastic waste to produce pyrolysis gases at a first temperature of around 350° C. to around 425° C., and pyrolysis slurry or pyrolysis char at a second temperature of around 722° C. to around 1400° C. The first temperature may be around 390° C. to around 410° C., and the second temperature may be around 1000° C. to around 1200° C. The pyrolysis reactor vessel 4 may be made from a high-temperature specialty alloy that may be heat resistant up to the second temperature without decomposition of the reactor construction. Non-limiting examples of suitable high-temperature specialty alloys may be selected from those alloys commercially available from Manoir under the tradename Manaurite, and from those commercially available from Kubota, Schmidt and Clemens, Poweralloy, etc., The pyrolysis reactor vessel 4 may, for example, be formed as a static casting of the high-temperature specialty alloy.

The process of creating pyrolysis char may be facilitated and enhanced due to the ability to raise the pyrolysis reactor vessel 4 and its contents to greater temperatures than previously possible with conventional pyrolysis reactor vessels made from high-temperature stainless steel that are limited to temperatures below around 721° C.

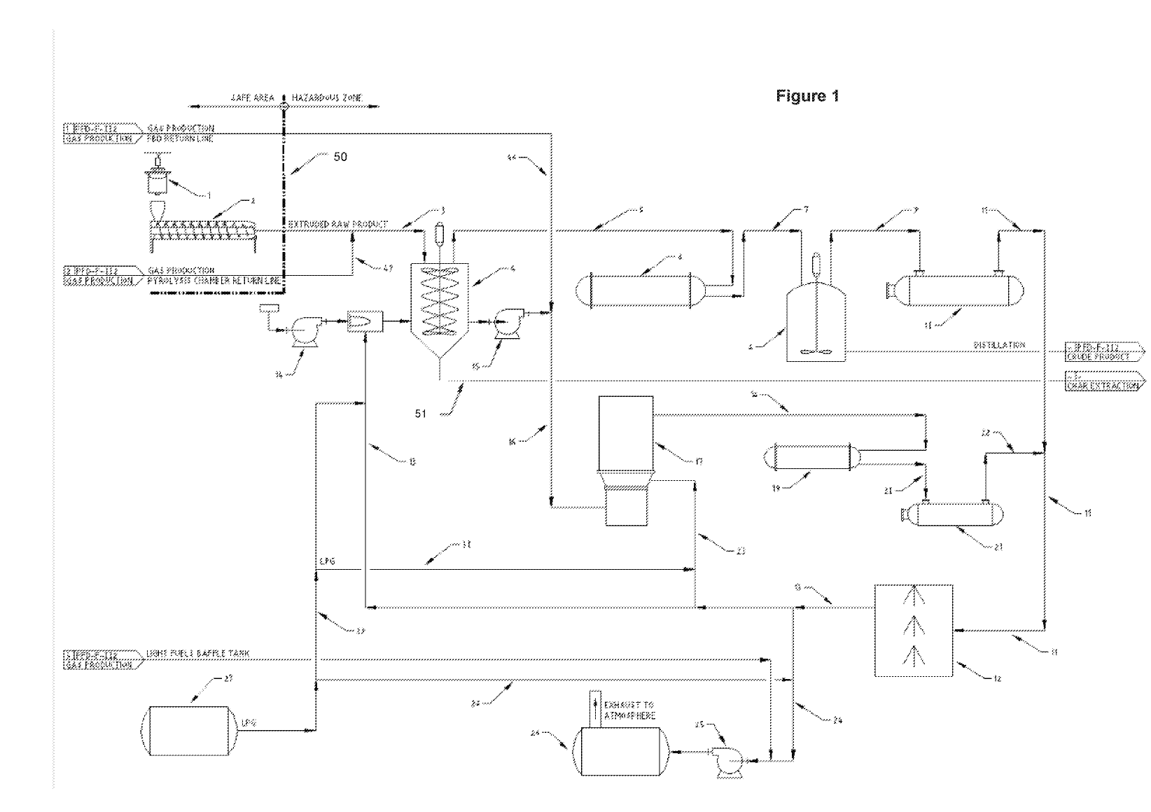

Referring again to FIG. 1, an outlet 5 from the pyrolysis reactor vessel 4 may be connected to a first condenser 6. The pyrolysis gas and vapour products may be carried over through the condenser 6 and cooled to around 180° C. before depositing in a buffer (or break) tank 8. The pyrolysis reactor vessel 4 may continue to be heated until a specified mass fraction remains, at which point the pyrolysis char and pyrolysis slurry may be pumped out. An outlet 7 from the first condenser 6 may be connected to the buffer tank 8.

As the mixed plastic waste feedstock varies in composition of HDPE, PET, PP, PS, etc, the pyrolysis gases, condensates and condensed vapours may also reform to produce a varying yields of hydrocarbon liquid, and the flow rate of the resulting liquid may also vary. The buffer tank 8 may act as a high temperature storage facility to accommodate immediate production of pyrolysis condensates at around 180° C. to around 200° C., and may offer a residence time so that pyrolysed product may be maintained in a homogeneous state and analysed for its hydrocarbon properties prior to downstream separation processing.

The pyrolysis reactor vessel 4 may be connected by pipe 5 to the condenser 6 that may be configured to receive the pyrolysis gases from the pyrolysis reactor vessel 4, and to cool and condense the pyrolysis gases to a third temperature of around 150° C. to around 250° C. to produce pyrolysis condensates. The third temperature may be around 180° C. to around 200° C. The pipe 5 may be maintained at the third temperature by a jacket of hot oil (not shown) to prevent undesirable reaction. Pyrolysis gases and vapours that evolve during the pyrolysis process may escape via the adjoining pipe 5 into the closely located condenser 6. The condenser 6 may lower the temperature of the pyrolysis gases and vapours to around 180° C. to around 200° C. to form liquid as it exits. Cooling water may be used to assist performance of the condensation. The pyrolysis reactor vessel 4 contents may be monitored by the load cells, and the pyrolysis reaction may be analysed via comparison of product mass with gas and/or liquid flow. Ambient conditions (eg, temperature, humidity and pressure) may affect mass balance, and adjustments may be made to the load cells and/or mass calculations. The pipe work 5 connecting the outlet of the pyrolysis reactor vessel 5 to the condenser 6 may be heat traced and controlled to maintain mass flow.

The condenser 6 may be connected by pipe 7 to the buffer tank 8 that may be configured to receive the pyrolysis condensates from the condenser 6, and to mix the pyrolysis condensates to produce a homogenous mixture thereof. The buffer tank 8 may be further configured to maintain the homogeneous mixture of the pyrolysis condensates at the third temperature. For example, the buffer tank 8 may have heating coils, and may be thermally insulated. The pyrolysis reactor vessel 4 and the buffer tank 8 may each comprise an internal agitator to assist transfer of heat internally. The continuously agitated buffer tank 8 may store the pyrolysis products at around 180° C. to around 200° C. for analysis. This analysis may be used to determine downstream processing, such as distillation, separation, additive injection, blending, and combinations thereof. The buffer tank 8 may advantageously buffer the variability in pyrolysis product volumes and compositions. This may allow for chemical analysis to take place, with the configuration and operation of a distillation column being based on the results of the analysis.

An upper part of the buffer tank 8 may be connected via an outlet 9 to a first knock-out drum 10. An outlet 11 from the first knock-out drum 10 may be connected to a scrubber 12. The condenser 6 and knock-out drum 10 may be present to separate non-condensable pyrolysis gases for use within the process, returning pyrolysis liquids to the buffer tank 8. Pyrolysis vapours may be prevented from entering the atmosphere and are trapped by the connection into the knock-out drum 10 that further condenses and traps carry over vapours. The knock-out drum 10 may be partially filled with a controlled level of cooling water and a baffle plate to separate any hydrocarbon product. The interface may be monitored and controlled with makeup water only. The outlet of the knock-out drum 10 may be directed to the gas scrubber 12 to further treat the gases. The scrubber 12 may treat the gases for optimal combustion prior to being recycled into the process.

The non-condensable pyrolysis gases may be harvested and used for heating plant equipment performing the process. The scrubber 12 may be installed to clean the non-condensable pyrolysis products in preparation for combustion. The heated thermal oil may then be used instead of electrical energy as required through the plant and process, for example, around the heated screw extruder 2, maintaining temperature in the buffer tank 8, heat tracing of process lines, jackets, and pipes, etc.

An outlet 13 from the scrubber 12 may be connected to a gas burner 14 that may be mounted to a lower part of the pyrolysis reactor vessel 4. Further or alternatively, the lower part of the pyrolysis reactor vessel 4 may be heated by induction heating elements (not shown). The use of induction heating may more efficiently and accurately control temperature and consistent production of pyrolysis gases and vapours. This may also eliminate a naked flame in the hazardous zone, and may result in a reduction in pulsing during production. As the pyrolysis reactor vessel 4 may be at least partially induction heated, the syngas which was used prior for burner fuel may instead be redirected to an electrical generation system used to power the pyrolysis plant. The calorific value of the syngas may be potentially greater than natural gas, and may be used as part of the energy requirements to operate the facility. Apart from being technically advantageous, this reuse of the excess gas created by the process, may optimise the long term economics of the plant.

A lower part of the pyrolysis reactor vessel 4 may be connected by a pump 15 and a line 16 to a fluidised bed heater 17. The pyrolysis reactor vessel 4 load cells may weigh one or more of the molten mixed plastic waste, the pyrolysis slurry and the pyrolysis char in the pyrolysis reactor vessel 4. This may enable the process and its efficiency to be monitored and controlled on a mass basis. For example, the pyrolysis slurry or the pyrolysis char may be transferred or pumped from the pyrolysis reactor vessel 4 to a fluidised bed heater 17 when a weight percentage of greater than around 70% of the molten mixed plastic waste has been pyrolysed. The weight percentage may, for example, be around 80%. The weight percentage used to trigger activation of the pump 15 may be varied based on variation in the mixed plastic waste feedstock.

The pump 15 to empty the pyrolysis reactor vessel 4 may be activated when the contents of the pyrolysis reactor vessel 4 become non-productive, and the contents may be transferred in slurry state for the purposes of char and gas production. Pyrolysis slurry may be transferred via the heat controlled line 16 to the fluidised bed heater 17. The fluidised bed heater 17 may heat the slurry product to a temperature around 1000° C. to around 1400° C. that may be sufficient to remove all traces of hydrocarbon and produce an inert char that may be divested of all energy, and which does not pose a risk to the environment or plant personnel. This additional high-temperature processing may allow for reduction or elimination of impurities and biological contaminants from the pyrolysis char. A turnstile-type char discharge system (not shown) may be fitted to break up any solid matter and may allow for evacuation of the pyrolysis reactor vessel 4 via a negative pressure. The inert char may be disposed of as land fill. In completely drying the char, not only may all the energy be driven from the material for use elsewhere, but the resulting material may also be inert.

The fluidised bed heater 17 may accept the char slurry in a batch wise fashion at the completion of each pyrolysis cycle, drying it and driving off any remaining hydrocarbons. The temperatures employed in this plant equipment may extend beyond the temperature in the pyrolysis reactor vessel 4, resulting in complete char drying and a resultant inert char product. The hydrocarbons derived in the fluidised bed may be harvested for their calorific value, which may be utilised within the plant. The return line fluidised bed heater 17 may allow for liquid product to be returned to a gaseous state while creating char. A return line to the pyrolysis reactor vessel 4 may provide the ability to enhance the pyrolysis reaction based on raw product type and composition, and may close the loop on the pyrolysis production process. At the completion of each char drying process the char in its inert state may be removed. A char extraction system 51 may be provided to cool the inert char to a safe temperature while transferring to a storage container. This char extraction system 51 may be remotely and selectively actuated by an operator.

An outlet 18 from the fluidised bed heater 17 may be connected to a second condenser 19 that may be connected via an outlet 20 to a second knock-out drum 22. An outlet 22 from the second knock-out drum 22 may be connected to the outlet 11 that feeds into the scrubber 12. A first branch 23 may be connected from the outlet 13 of the scrubber 12 to the fluidised bed heater 17.

A second branch 24 may be connected from the outlet 13 of the scrubber 12 via a blower 25 to a thermal oxidiser oil heater 26. The blower 25 may be controlled to maintain consistent upstream process pressure and flow which may be a critical aspect of the process. The process at this point may be kept at a controlled flow and pressure value in order to maximize the transfer of process gasses and inventory upstream. The hot oil system may be integrated into the thermal oxidiser oil heater 26 and may be incorporated for all plant heating circuits and for prevention of solids build up. In addition, the hot oil system may provide heating supply to maintain all pipe work described above in paragraphs [0056] to [0059] at elevated temperatures to prevent undesirable reformation of pyrolysis products. Furthermore, all transfer pumps may be heat traced and thermally insulated to prevent blockages. Exothermic and excess (syngas) gases may be transferred back into process for purpose of reuse. By burning process gases in the oil heater 26, overall process energy efficiency may be improved, as this heated oil may then be used in the heating of vessels and heat tracing of jackets, eliminating the more expensive and less efficient electrical heat tracing. Plant heating may be performed by transferring heat into a mineral oil and then circulating it at a maximum temperature of around 250° C. to the heating elements within the plant and process, such as exchangers and trace tubing. Electrical heat tracing and general electric heating may be included as an alternative to hot oil while the plant may be dormant or in a pre-start up phase. The thermal oxidiser oil heater 26 may be able to dispose of both endothermic and exothermic gases whilst simultaneously heating hot oil for the purposes of plant heating and tracing. An LPG supply vessel 27 may be connected via a line 28 to the second branch 24 that feeds the blower 25 to the thermal oxidiser oil heater 26 that exhausts to the atmosphere. A line 29 may connect the LPG supply vessel 27 to the outlet 13 that feeds the burner 14.

A condensate analyser (not shown) may be configured to analyse contents of the buffer tank 8 to determine downstream processing of the contents. The analyser may comprise sensors connected to a processor programmed with software that may be configured to analyse the homogenous mixture of the pyrolysis condensates in the buffer tank 8 to determine suitable downstream processing of the homogenous mixture of the pyrolysis condensates to produce fuel products.

The buffer tank 8 may make simultaneous and multiple processing feasible. Upstream reactions that are unstable as a result of pulsed or varying production rates may be undesirable when trying to determine optimal yield parameters. Variations in flow, pressure and temperature may be normally too difficult or complex to control. The homogeneously mixed product in the buffer tank 8 may be analysed and compared against the raw feedstock product, and this may allow the downstream processing parameters and product selection stream to be efficiently determined with greater economic benefit. Refinement or blending of product may take place at another location or in distillation process that may be remotely located.

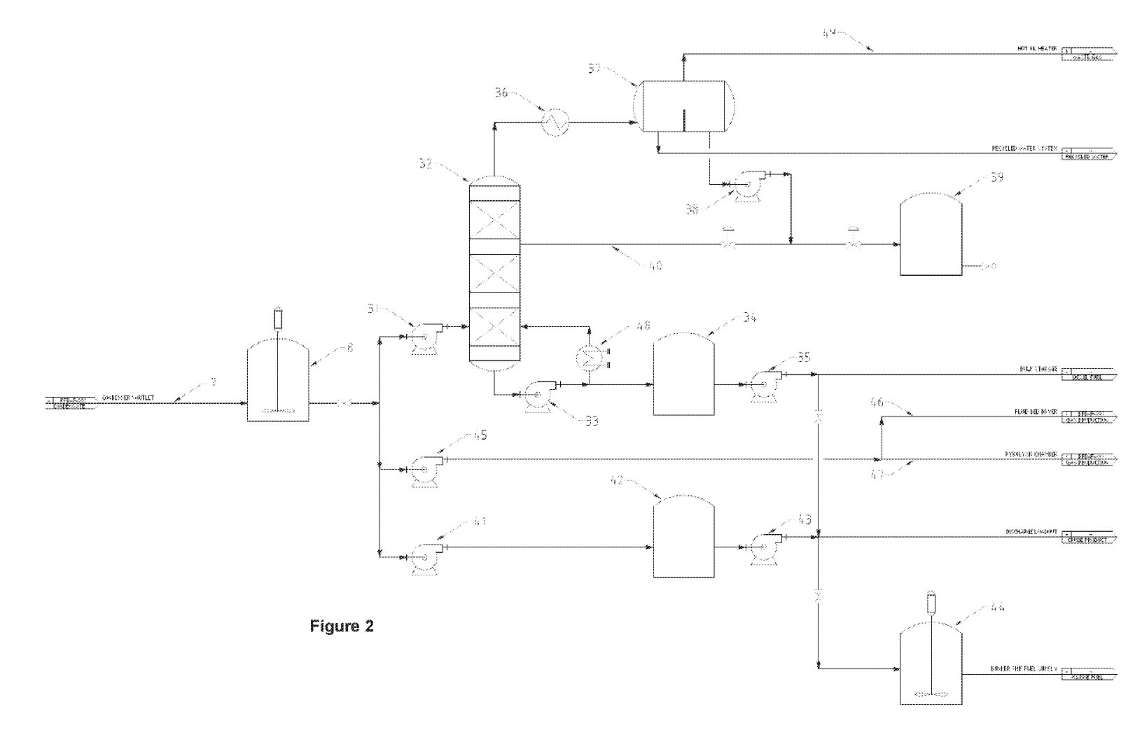

Referring to FIG. 2, depending on the analysis of the contents of the buffer tank 8, an outlet from the buffer tank 8 may be optionally connected by a valve and via a pump 31 to a distillation column 32. The buffer tank 8 may make it possible to create a consistent flow into a separation apparatus, such as the distillation column 32, resulting in a more controllable process. The process may allow for setting of optimal temperatures at the distillation column 32 to produce an efficient method of separating of hydrocarbon which targets production of C₁₀ to C₂₀ carbon chains, and may give options to a broader product range outside that of fuel production. Upon analysis of buffer tank 8 contents, products may be pumped at a consistent and predetermined flow rate to the distillation column 32. The distillation column 32 may separate out diesel fuel product as a priority final product.

Diesel fuel may be pumped from a lower part of the distillation column 32 by a pump 33 to diesel fuel storage 34. The diesel fuel storage 34 may be connected via a pump 35 to bulk storage. A branch from the outlet of the pump 33 may be connected to a re-boiler 48 that feeds back into the lower part of the distillation column 32. Diesel fuel product may be pumped out to an intermediate storage facility for analysis. The diesel intermediate storage tank may be monitored for quality to maintain production specification. Diesel may be discharged to bonded storage facility or blended into the crude product.

An upper part of the distillation column 32 may be connected via a light fuels heat exchanger 36 to a light fuels baffle tank 37. Waste gas from the light fuels baffle tank 37 may be fed via a line 49 to a hot oil heater. Light fuels or light fuel fractions may be fed via a pump 38 to a light fuels storage tank 39. Light fuels may also be recirculated by the pump 38 via a line 40 to the distillation column 32 for use as reflux in the distillation column 32.

The outlet from the buffer tank 8 may be optionally connected by the valve to a pump 45 to feed gas from the buffer tank 8 to the pyrolysis reactor vessel 4 via a line 47. The gas from the buffer tank 8 may also be fed to the fluidised bed heater 17 via a branch 46 off the line 47.

The outlet from the buffer tank 8 may be optionally further connected by the valve to a pump 41 to feed crude fuel product to crude product storage 42. The output from the crude product storage 42 may be fed via a pump 43 to a crude product discharge, or to marine fuel storage 44. The plant may be optionally provided on a sea vessel (not shown), and the marine fuel storage 44 may be connected to a marine fuel supply of the sea vessel.

The process may be suitable for static or mobile facilities. For example, the plant and process may be portable or located on board a ship that may be fuelled by mixed plastic waste product that has been trawled from the ocean. The process and plant may therefore be used in a marine system on board a marine vessel where waste treatment activity takes place while providing fuel to the vessel to reduce or eliminate refuelling costs and time in port. Gas and light fuel production may also form part of the final product processing stream.

Crude and/or raw product may be produced for the purposes of blending and treatment for use as marine or bunker fuel. The crude/raw product may be treated in an intermediate storage tank and may be prepared for use as marine fuel. The contents may be discharged into an onshore facility for storage or treatment. Where the plant is located on a marine vessel, neat or blended product may be discharged into an on board blending system. The on-board blending tank may accept a predetermined ratio of diesel and raw product for use as marine fuel. Raw product from the intermediate storage tank may be used as part of a gasification process for the purposes of additional electrical generation or heating.

Embodiments of the present invention provide a pyrolysis plant and process that are useful for efficiently converting mixed plastic waste feedstock into useful pyrolysis products, including syngas, inert char and fuel products, such as crude oil, diesel, bunker fuel, light fuel fractions, and combinations thereof.

For the purpose of this specification, the word “comprising” means “including but not limited to,” and the word “comprises” has a corresponding meaning.

The above embodiments have been described by way of example only and modifications are possible within the scope of the claims that follow.

1. A plant, comprising:
a pyrolysis reactor configured to heat molten mixed plastic waste to produce:
pyrolysis gases at a first temperature of around 350° C. to 425° C.; and
pyrolysis slurry or pyrolysis char at a second temperature of 722° C. to 1400° C.

2. The plant of claim 1, wherein the first temperature is around 390° C. to 410° C.

3. The plant of claim 1, wherein the second temperature is around 1000° C. to 1200° C.

4. The plant of claim 1, wherein the pyrolysis reactor is further configured to agitate the molten mixed plastic waste at the first temperature.

5. The plant of claim 1, wherein the pyrolysis reactor is provided on load cells configured to measure a percentage weight loss of the molten mixed plastic waste in the pyrolysis reactor.

6. The plant of claim 1, wherein the pyrolysis reactor is made from a specialty alloy that is heat resistant up to the second temperature.

7. The plant of claim 1, wherein the pyrolysis reactor is heated by induction heating, gas burner heating, or a combination thereof.

8. The plant of claim 1, further comprising a condenser configured to receive the pyrolysis gases from the pyrolysis reactor, and to cool and condense the pyrolysis gases to a third temperature of around 150° C. to 250° C. to produce pyrolysis condensates.

9. The plant of claim 8, wherein the third temperature is around 180° C. to 200° C.

10. The plant of claim 8, further comprising a buffer tank configured to receive the pyrolysis condensates from the condenser, and to mix the pyrolysis condensates to produce a homogenous mixture thereof.

11. The plant of claim 10, wherein the buffer tank is further configured to maintain the homogeneous mixture of the pyrolysis condensates at the third temperature.

12. The plant of claim 1, further comprising a heated extruder configured to extrude and heat mixed plastic waste feedstock to an initial temperature of around 280° C. to around 320° C. to form the molten plastic waste that may be fed into the pyrolysis reactor vessel.

13. The plant of claim 12, wherein the initial temperature of the molten plastic waste is around 300° C.

14. The plant of claim 1, further comprising a fluidised bed heater configured to receive the pyrolysis slurry or the pyrolysis char from the pyrolysis reactor, and to heat and dry the pyrolysis slurry or the pyrolysis char at the second temperature.

15. The plant of claim 10, further comprising a knock-out drum and a scrubber connected in series from an output of the buffer tank, and configured to separate non-condensable pyrolysis gases from the pyrolysis condensates.

16. The plant of claim 15, further comprising a heater configured to receive the non-condensable pyrolysis gases from the scrubber, and to combust the non-condensable pyrolysis gases to heat one or both of the pyrolysis reactor and the buffer tank.

17. The plant of claim 10, further comprising a condensate analyser configured to analyse the homogenous mixture of the pyrolysis condensates in the buffer tank to selectively determine downstream processing of the homogenous mixture of the pyrolysis condensates to selectively produce fuel products.

18. The plant of claim 17, further comprising downstream processing apparatus configured to selectively receive the homogenous mixture of pyrolysis condensates from the buffer tank and, based on the analysing, to selectively process the homogenous mixture of the pyrolysis condensates to produce the fuel products.

19. The plant of claim 18, wherein the downstream processing apparatus are selected from a condenser, a fractionator, a distillation column, and combinations thereof.

20. The plant of claim 18, wherein the fuel products are selected from syngas, crude oil, diesel, bunker fuel, light fuel fractions, and combinations thereof.

21. A process, comprising:
heating molten mixed plastic waste in a pyrolysis reactor to produce:
pyrolysis gases at a first temperature of around 350° C. to around 425° C.; and
pyrolysis slurry or pyrolysis char at a second temperature of around 722° C. to around 1400° C.

22. The process of claim 21, wherein the first temperature is around 390° C. to around 410° C.

23. The process of claim 21, wherein the second temperature is around 1000° C. to around 1200° C.

24. The process of claim 21, further comprising agitating the molten mixed plastic waste at the first temperature.

25. The process of claim 21, further comprising weighing one or more of the molten mixed plastic waste, the pyrolysis slurry and the pyrolysis char in the pyrolysis reactor.

26. The process of claim 21, further comprising heating the pyrolysis reactor by induction heating, gas heating or a combination thereof.

27. The process of claim 21, further comprising cooling and condensing the pyrolysis gases to a third temperature of around 150° C. to around 250° C. to produce pyrolysis condensates.

28. The process of claim 27, wherein the third temperature is around 180° C. to around 200° C.

29. The process of claim 27, further comprising mixing the pyrolysis condensates in a buffer tank to form a homogenous mixture thereof.

30. The process of claim 29, further comprising maintaining the homogeneous mixture of the pyrolysis condensates at the third temperature.

31. The process of claim 21, further comprising extruding and heating mixed plastic waste feedstock to an initial temperature of around 280° C. to around 320° C. to form the molten plastic waste that is fed into the pyrolysis reactor vessel.

32. The process of claim 31, wherein the initial temperature is around 300° C.

33. The process of claim 21, further comprising heating and drying the pyrolysis slurry or the pyrolysis char at the second temperature in the pyrolysis reactor or a fluidised bed heater.

34. The process of claim 25, further comprising transferring the pyrolysis slurry or the pyrolysis char from the pyrolysis reactor to the fluidised bed heater when a weight percentage of greater than around 70% of the molten mixed plastic waste has been pyrolysed.

35. The process of claim 34, wherein the weight percentage is around 80%.

36. The process of claim 29, further comprising separating non-condensable pyrolysis gases from the pyrolysis condensates.

37. The process of claim 36, further comprising combusting the non-condensable pyrolysis gases to heat one or both of the pyrolysis reactor and the buffer tank.

38. The process of claim 29, further comprising analysing the homogenous mixture of the pyrolysis condensates in the buffer tank to determine downstream fractionating of the homogenous mixture of the pyrolysis condensates to produce fuel products.

39. The process of claim 38, further comprising, based on the analysing, selectively downstream processing the homogenous mixture of the pyrolysis condensates to selectively produce the fuel products.

40. The process of claim 39, wherein the downstream processing is selected from condensing, fractionating, distilling, and combinations thereof.

41. The process of claim 39, wherein the fuel products are selected from syngas, crude oil, diesel, bunker fuel, light fuel fractions, and combinations thereof.

42. Fuel products made by the plant of claim 1, or he process of claim 21.

43. The fuel products of claim 42, wherein the fuel products are selected from syngas, crude oil, diesel, bunker fuel, light fuel fractions, and combinations thereof.

44. A method, comprising pyrolysing or disposing of mixed plastic waste at sea using the plant of claim 1, or the process of claim 21.
